(19) United States
(12) Patent Application Publication
(10) Pub. No.: US 2026/0080791 A1
(43) Pub. Date: Mar. 19, 2026

(54) DIGITAL TRAINING SYSTEM AND METHOD

(71) Applicant: Grand River Solutions, Saratoga, CA (US)

(72) Inventors: Joseph STORCH, Delmar, NY (US); William BOERNER, Silver Creek, NY (US); Anna SOTELO-PERYEA, Buffalo, NY (US); Morgan CLIFFORD, Troy, NY (US); Roma SHAH, Glen Cove, NY (US); Jui STEFFEN, New York, NY (US); Jody SHIPPER, Napa, CA (US); Cherie SCRICCA, Napa, CA (US); Cassio CONCEICAO, Los Altos, CA (US)

(21) Appl. No.: 18/888,073

(22) Filed: Sep. 17, 2024

(51) Int. Cl. G09B 5/06; G06F 16/958

(52) U.S. Cl. CPC G09B 5/06; G06F 16/958

(57) ABSTRACT

According to one example, there is a training system including a processor and a non-transitory computer-readable medium including computer executable instructions for configuring the processor to carry out a method including: providing an electronic user interface for a trainee to login and remotely access training materials via a web-based content access user interface; matching a trainee identification to at least one of a group of parameters; selecting a first training video for the trainee to view based upon the matching step, the first training video having a first topic and a first time of play; initiating play of the first training video; monitoring behavior of the trainee as they view the first training video; selecting a second training video for the trainee to view based upon the monitoring step; initiating play of the second training video; and monitoring behavior of the trainee as they view the second training video.

### PRIORITY CLAIM

None.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Institutional and educational training in the digital age suffers from a lack of user engagement and innovation. Required trainings for employees and members of various companies, institutions, and industries often involves lengthy and boring generic videos with quizzes and knowledge checks that users wade through without being engaged or feeling connected to outdated or uninspiring content that do not drive meaningful behavioral change such as preventing harassment and violence. This is detrimental to disseminating and educating users about institutional policies, objectives, regulations, laws, or other concepts, and giving users practical and executable resources and trainings to learn and engage with material. Instead, it can often result in user apathy and negative emotions towards trainings and the administrative leadership, often represented by human resources departments of organizations that create and administer trainings.

Accordingly, there is a need for relevant, innovative, and engaging digital training content from diverse content creators that can be easily customized to and adapted to users in various settings to promote effective learning and behavior change.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 shows a content access and creation overview user interface for an exemplary training system.

FIG. 2 shows a video content user interface for the exemplary training system.

FIG. 3 shows a survey user interface for the exemplary training system.

FIG. 4 shows a learning user interface for the exemplary training system.

FIGS. 5A-5B show a client user interface for the exemplary training system.

FIG. 6 shows a content creator user interface for the exemplary training system.

FIG. 7 shows an application administrator user interface 700 for the exemplary training system.

FIG. 8A shows a video browsing user interface for the exemplary training system.

FIG. 8B shows an exemplary video user interface 801 for a specific video in the exemplary training system.

FIG. 9 shows a settings user interface for the exemplary training system.

FIG. 10 shows support user interface for the exemplary training system.

FIG. 11 shows a system notifications user interface for the training system.

FIG. 12 shows a system preferences user interface for the exemplary training system.

FIGS. 13A-13B is a flow chart illustrating an exemplary method performed in a training system comprising a web-based content access user interface.

FIGS. 14A-14B is a flow chart illustrating an exemplary method of creating training content by a training content provider.

FIG. 15 is a flow chart illustrating an exemplary method of engagement between a client and a training content provider.

### DETAILED DESCRIPTION

In general, described herein are digital training systems and methods. According to one embodiment, there is an exemplary training system, including a web-based content access user interface, including a processor and a non-transitory computer-readable medium including computer executable instructions for configuring the processor to carry out a method including: providing an electronic user interface that allows a trainee to remotely access training materials via the web-based content access user interface; allowing the trainee to login to the exemplary training system; matching a trainee identification to at least one of a group consisting of client provided demographic data, past trainee behavior, similar trainee statistics, trainee responses to knowledge checks, and percentage completion data; selecting a first training video for the trainee to view based upon the matching step, the first training video having a first topic and a first time of play; initiating play of the first training video; monitoring behavior of the trainee as they view the first training video; selecting a second training video for the trainee to view based upon the monitoring step; initiating play of the second training video; and monitoring behavior of the trainee as they view the second training video.

According to examples of this embodiment, the first monitoring behavior step comprises at least one step selected from a group consisting of monitoring whether the trainee views the first training video in its entirety, rewatches the first training video, partially watches the first training video, responds positively or negatively to the first training video, saves the first training video, and indicates whether they do not want to view the first training video.

According to examples of this embodiment, the step of monitoring whether the trainee indicates they do not want to view the first training video comprises monitoring whether the trainee swipes away or clicks away from the first training video.

According to examples of this embodiment, the training system refines an algorithm used to match the trainee identification to training materials, the refining of the algorithm including at least one step selected from a group consisting of monitoring additional trainee behavior, comparing statistics from similar trainees or similar identities, analyzing a percentage of completion of training materials by time or topics, computing a number of seconds of video watched, and analyzing a long term effectiveness of particular training materials.

According to examples of this embodiment, the refining of the algorithm used to match the trainee identification to training materials includes an artificial intelligence method including: gathering trainee use data from multiple trainees; cleansing and transforming the use data; storing the use data for analysis; inputting the stored use data into a modeling and training process to arrive at a preliminary training material content recommendation for the trainee; testing the preliminary recommendation to arrive at a final vetted recommendation; and providing the final recommendation to the trainee.

According to examples of this embodiment, the first training video and the second training video are created by one or more of: peers of the trainee and non-peer experts.

According to examples of this embodiment, the first training video and the second training video are curated by operators of the training system before they can be viewed by the trainee.

According to examples of this embodiment, the one or more of peers of the trainee and non-peer experts are compensated by the operators of the training system for creating the first training video and the second training video.

According to examples of this embodiment, the web-based content access user interface includes a client application.

According to examples of this embodiment, the client application is configured to run on a smart phone.

According to examples of this embodiment, the web-based content access user interface includes a client web browser accessing a website of an operator of the training system.

According to examples, the training materials include training content on one or more of: sexual harassment, misconduct, public health, and legal compliance.

According to examples of this embodiment, the training system is further configured to track trainee compliance and provide certification.

According to examples of this embodiment, the training materials include student-facing or employee-facing training around sexual and interpersonal violence and harassment under the Clery Act of 1990, Title IX of the Education Amendments of 1972, and other relevant federal and state laws.

According to another embodiment, there is a non-transitory computer-readable medium including computer executable instructions for carrying out a method, performed in a training system comprising a web-based content access user interface, the method including: providing an electronic user interface that allows a trainee to remotely access training materials via the web-based content access user interface; allowing the trainee to login to the training system; matching a trainee identification to at least one of a group consisting of client provided demographic data, past trainee behavior, similar trainee statistics, trainee responses to knowledge checks, and percentage completion data; selecting a first training video for the trainee to view based upon the matching step, the first training video having a first topic and a first time of play; initiating play of the first training video; monitoring behavior of the trainee as they view the first training video; selecting a second training video for the trainee to view based upon the monitoring step; initiating play of the second training video; and monitoring behavior of the trainee as they view the second training video.

According to examples of this embodiment, the first monitoring behavior step includes at least one step selected from a group consisting of monitoring whether the trainee views the first training video in its entirety, rewatches the first training video, partially watches the first training video, responds positively or negatively to the first training video, saves the first training video, and indicates whether they do not want to view the first training video.

According to examples of this embodiment, the step of monitoring whether the trainee indicates they do not want to view the first training video comprises monitoring whether the trainee swipes away or clicks away from the first training video.

In yet another embodiment, a training access workflow may include steps of a user, also called a viewer/trainee, logging into the training system via a client app or website, or through a training content provider's app or website. The viewer/trainee may have an ID or profile based on their personal data such as (for an exemplary viewer/trainee who is a university student): class status, race, gender, athletics, Greek life, etc. An algorithm may then match an ID of the viewer/trainee to various parameters including client provided demographic data, past trainee behavior, similar use statistics, and percentage completion (of time and topics) for previous training content if available. A first video may then be presented to the viewer/trainee, and the viewer/trainee may take several actions including watching the content, rewatching the content, partially watching or completing the content, rejecting or swiping the video away. Based on the viewer/trainee's response, the system or algorithm may present a second video and subsequent videos to the viewer/trainee. The algorithm may then refine the presented video content based on data from a plurality of viewer/trainee responses to the videos, for example from among responses of viewers/trainees having similar use or identity statistics, based on percentage completion or seconds watching, or long-term effectiveness tracking such as campus crime and violence statistics. Video content ranked high on engagement based on the algorithm including how many minutes the viewer/trainee viewed the content and how viral the content has gone (i.e. how many viewers/trainees have viewed the content) may then be presented to more viewers/trainees, and video content on more or related topics may also be created. The training system thus aims for end-user content accuracy, tailoring content to make content effective for trainees/viewers at different levels, including one or more of: a specific viewer/trainee, viewers/trainees with overlapping or common ID information, and even all trainees/viewers of the training system.

In examples of this embodiment, a client administrator may prepopulate video content shown to one or more viewers/trainees, for example based on their ID or profile. The client administrator may also choose or invite content creators. In yet other examples, stakeholders including academic and non-academic deans may also be provided a customized view into the training system to see completion statistics, popularity of video content, and content creator information.

In examples of this embodiment, the training system may serve vertical clients in various industries including university students and employee training around sexual and interpersonal violence and harassment under The Clery Act, Title IX, and state law, as well as K-12 training around sexual and interpersonal violence and harassment. Other clients and services may include government and corporate education and training across various topics including compliance, safety, licensing, and harassment prevention in various industries such as restaurants and hospitality, gyms and physical fitness, ride sharing services, and government agencies. The system can be used to serve legally required as well as non-required but best practice training of any type in any industry.

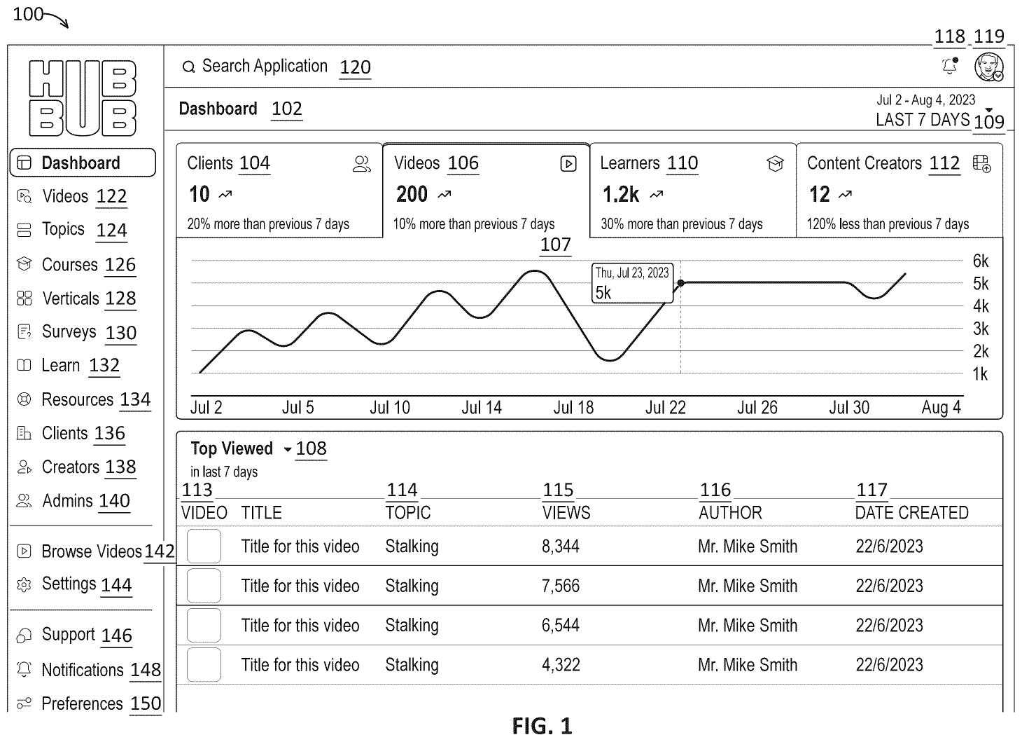

FIG. 1 shows an exemplary content access and creation overview user interface 100 for an exemplary training system. As shown, there is a dashboard 102 with tabs for clients 104, videos 106, a list of top viewed videos 108, a graph 107 showing the number of plays for a video or videos over a time period (which is customizable to a plurality of pre-populated time periods which can be selected via a drop-down menu 109), a learners tab 110, a resources tab 111, and a content creators tab 112. List of top viewed videos 108 may show an icon or link to a video 113 and display or be configured to be filtered by a topic 114, number of views total 115, author (such as a content creator) 116, and a date created 117. A notification icon 118 and a user icon 119 may also be shown, for example at the top of user interface 100, along with a search bar 120.

Other tabs or clickable icons on exemplary user interface 100 may include videos 122, topics 124, courses 126, verticals 128, surveys 130, learning tools 132, resources 134, clients 136, (content) creators 138, admins 140. There may also be tabs or clickable icons to browse videos 142, and for settings 144, support 146, notifications 148, and preferences 150.

Verticals icon 128 may be clicked to search for or display a list of related courses which may be required or optional in a training and may be added to a viewer/trainee's course list.

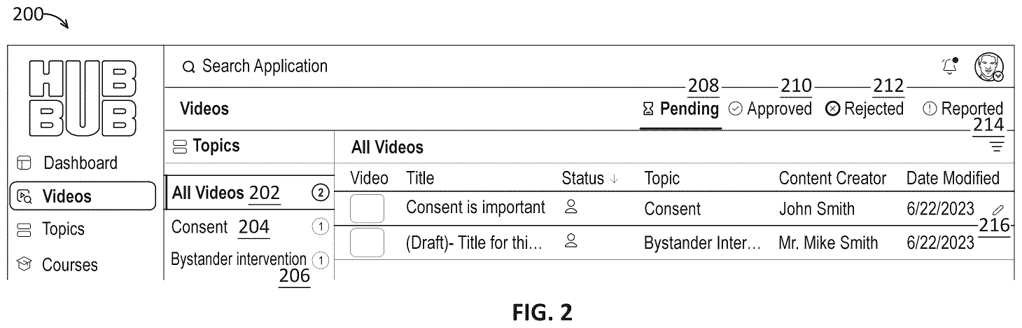

FIG. 2 shows an exemplary video content user interface 200 for the exemplary training system. In certain examples, the video content interface may be a social media style collection of video content that uses machine learning to tailor content to viewers/trainees, while compensating peer and non-peer expert creators to develop and grow the library of content. Such automated learning or machine learning offers the advantage of offering individualized training most likely to resonate with individual viewers/trainees as opposed to a generic one-size-fits-all training approach. In certain examples, modern social media style approaches to providing video content, for example based on viewers/trainees swiping or preferences, may be used to better engage viewers/trainees and provide them with more relevant training content.

For example, there may be clickable icons to display all videos 202, or by particular topics such as consent 204 and bystander intervention 206. Clickable and/or filterable lists may be displayed for video content that is pending 208, approved 210, rejected 212, and reported 214. In certain examples, the videos descriptions and/or content may be editable 216, for example by content creators.

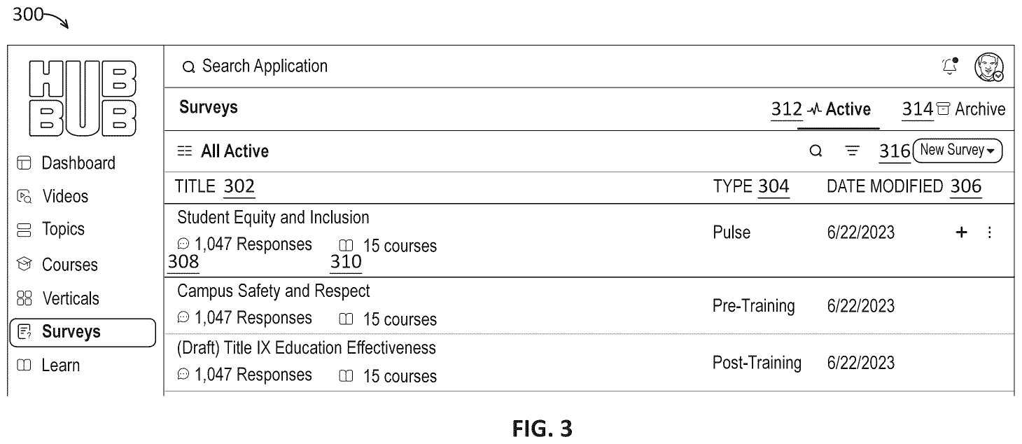

FIG. 3 shows an exemplary survey user interface 300 for the exemplary training system. Shown here are titles 302 of various surveys, including a survey type 304, date modified 306, as well as a number of responses 308 and a number of courses 310 that utilize a particular survey. There may be views for active surveys 312 and archived surveys 314. In a client or administrator view, surveys may be created by clicking on a new survey icon 316, for example pre-test surveys, pulse surveys with pop-up questions and activities during a training course, or post-test surveys.

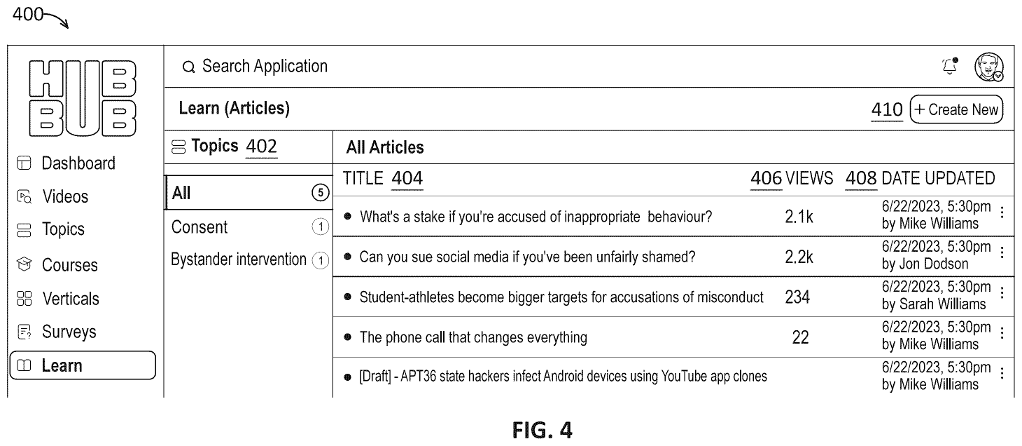

FIG. 4 shows an exemplary learning user interface 400 for the exemplary training system. Shown here are articles and learning resources, which may be organized by topics 402, with titles 404 which in certain examples may be clicked on to access the article. The number of views 406 of an article and the date the article was updated 408 is also shown. There may also be a feature to create new article 410, which may appear in a client or administrator view, and may allow embedding of images, and assigning of topic titles and meta-tags, as well as a suggestion for how long the article takes to read.

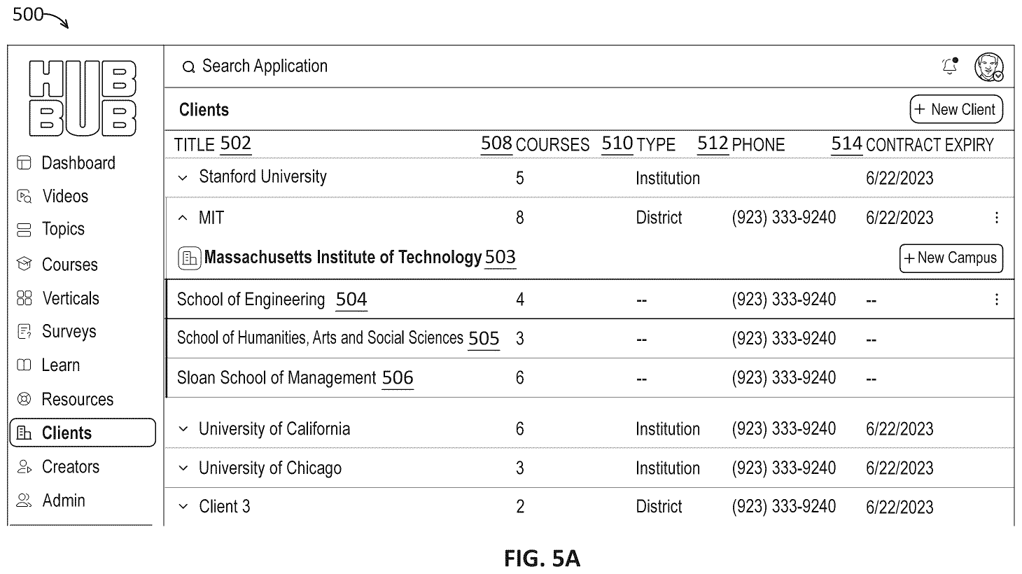

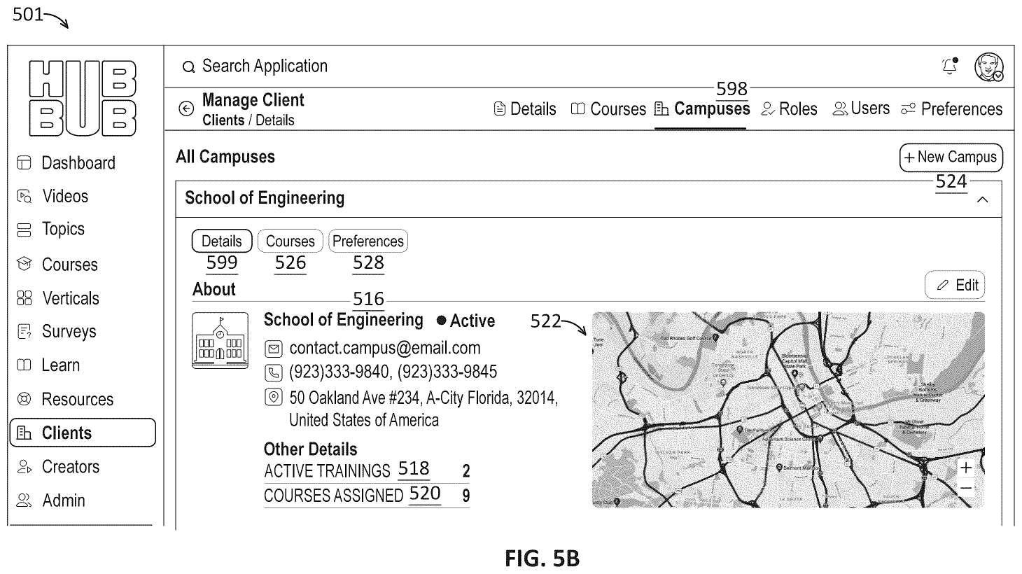

FIGS. 5A-5B show an exemplary client user interface for the exemplary training system.

FIG. 5A shows an exemplary clients user interface 500 with a list of clients by title 502 including sub-divisions or departments 504/505/506 for a client 503. The number of courses 508 for each institution is also shown, as well as client type 510, client phone number 512, and contract expiration date 514.

FIG. 5B shows an exemplary client department user interface 501 with details 599 for sub-divisions or department of a client institution such as campuses 598 for a client institution, including contact information 516, active trainees 518, and courses assigned 520, as well as a location map 522. New departments/campuses and contacts for departments/campuses may also be added via a clickable button 524. Information on courses 526 and preferences 528 for the department/campus may also be accessed.

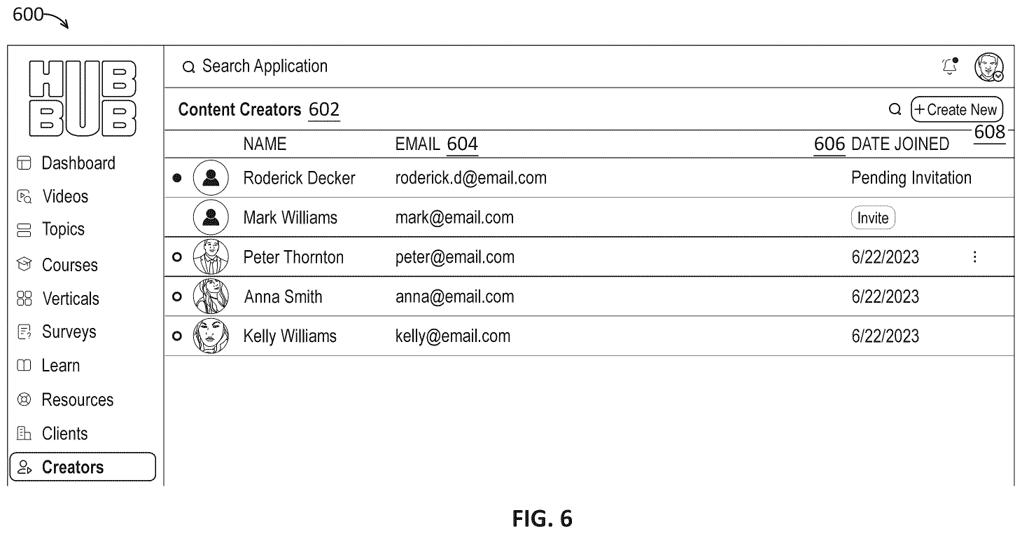

FIG. 6 shows an exemplary content creators user interface 600 for the exemplary training system. Shown here is a list which in certain examples may include names of content creators 602 including their e-mail addresses 604 and date joined or invited 606. New content creators may also be added, for example by administrators, via a clickable button 608.

In certain examples, content creators may be peers providing peer-to-peer educational content to better connect with viewers/trainees in the same organization, academic or institutional level/field, or industry. For example, content creators may be students creating content for viewers/trainees who are also students. This allows viewers/trainees to learn from content creators that may represent elements of their own multifaceted identities, and to also be exposed to new voices and perspectives.

A challenge for content creators recording visual content about laws, regulations, and other text-heavy items includes the need to either memorize them or look away from the camera to read documents while recording visual content, which makes it clear that the content creator is reading from materials, and results in a loss of eye contact with the viewer/trainee. Advantageously, the exemplary training system and one or more of its various embodiments may include an exemplary embedded teleprompter feature to maintain content creator eye contact with the camera. In certain embodiments, content creators will be able to turn the exemplary teleprompter feature on or off and the exemplary teleprompter feature may appear in an adjustable window screen when content creators use a front facing camera to record themselves in creating visual content such as a video. Using the exemplary teleprompter feature, content creators can input text to read or bullet points to reference as they record themselves. According to certain examples, content creators will be able to adjust the color and size of the text, the speed of the text scrolling, and other elements of the teleprompter feature such as manual scrolling and play/pause controls, while appearing to look directly into the camera.

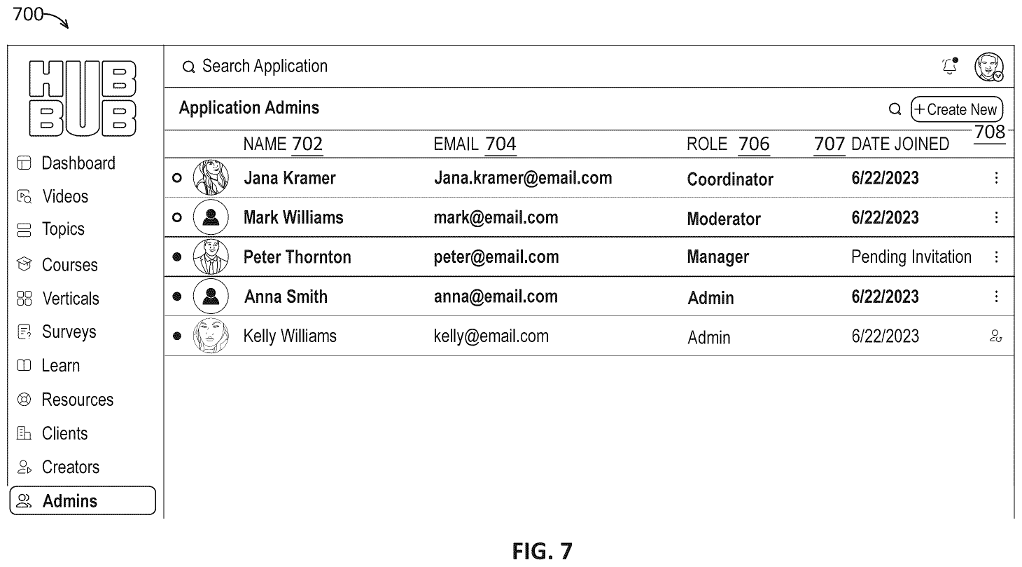

FIG. 7 shows an exemplary application administrator user interface 700 for the exemplary training system. Shown here is an exemplary list with names of administrators 702, their e-mail addresses 704, their roles 706 (such as coordinator, moderator, manager, admin, etc.), and the date 707 that they joined the exemplary training system. New administrators may also be added via a clickable button 708. According to certain embodiments, access permissions for administrators may be set by a super administrator regarding, for example, the view they have into client data and client user interfaces (client portal view).

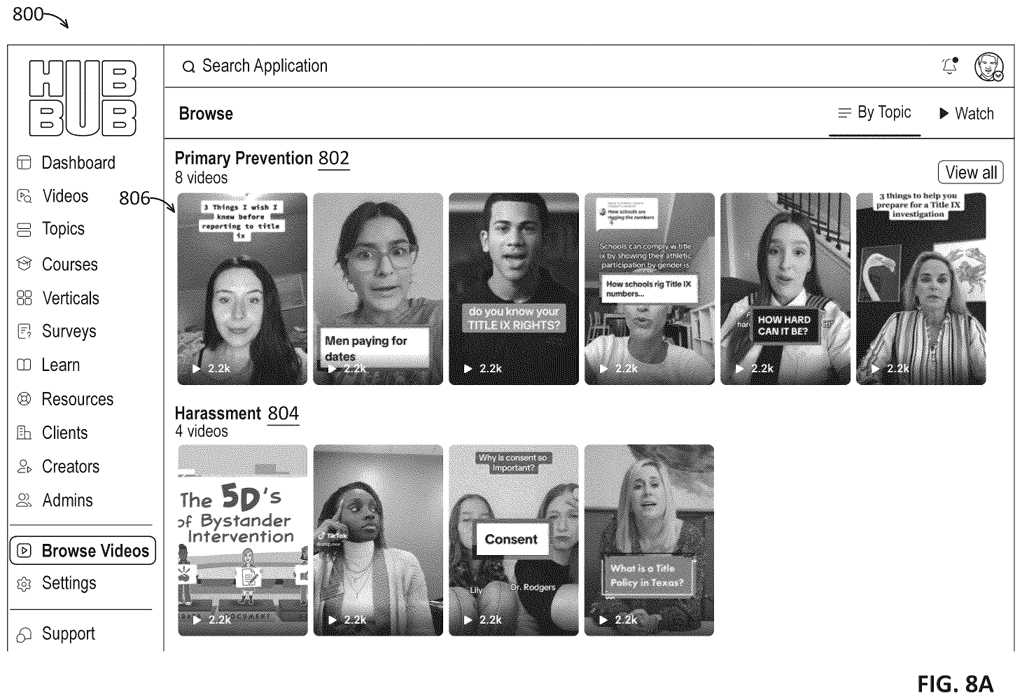

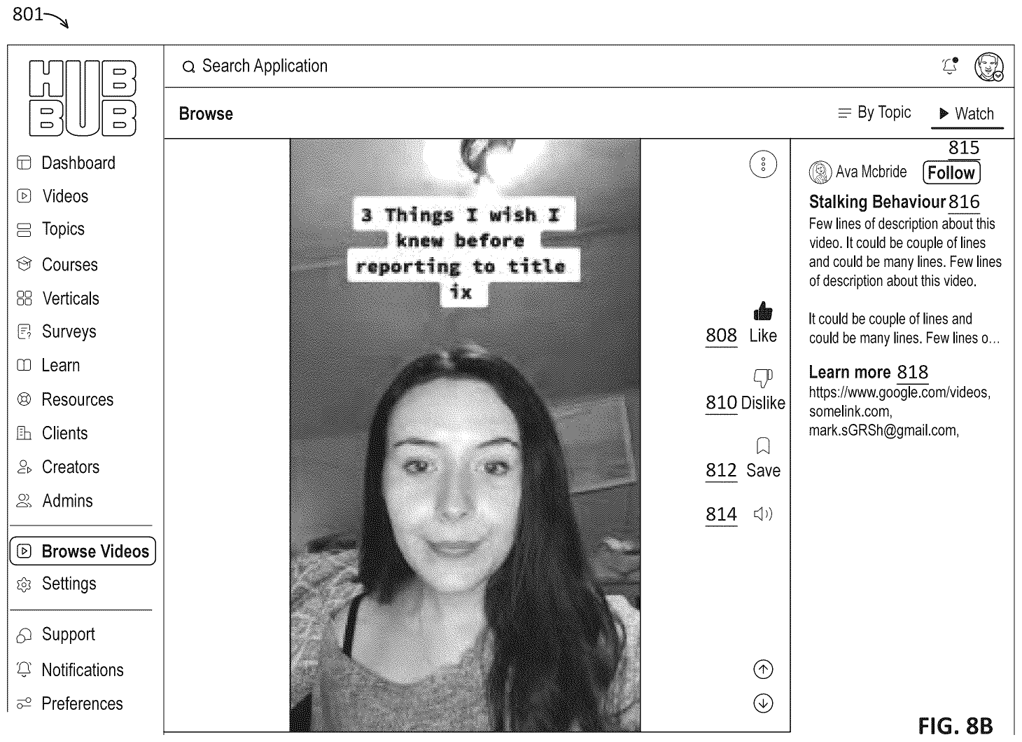

FIG. 8A shows an exemplary video browsing user interface 800 for the exemplary training system. Exemplary interface 800 shows a menu of videos under various topics such as primary prevention 802 and harassment 804. In certain examples videos, such as video 806, may be clicked on to watch. According to certain examples, content from additional content areas for required or optional training may be suggested or added to a viewer/trainee's exemplary video browsing user interface 800, an exemplary learning user interface, or other exemplary user interface, all based on the viewer/trainee's profile. For example, a student viewer/trainee undergoing sexual harassment training may also be suggested video content on sexual health, pandemic response, drunk driving, and other topics. Recommended video content may be based on various factors, including: climate surveys, pre-course knowledge and attitudes surveys, research, institutional data, content found to be effective for close peers of the viewer/trainee, peer interactions with the course, the viewer/trainee's own interactions with the course (such as speed of completion and level of engagement), and/or an algorithm of the exemplary training system.

FIG. 8B shows an exemplary video user interface 801 for a specific video in the exemplary training system. Viewers/trainees can click on various buttons such as like 808, dislike 810, save 812, and sound options 814. A link 815 to follow the content creator of the video may be displayed. There may also be a summary or description 816 of the specific video, and a link 818 to learn more about the video.

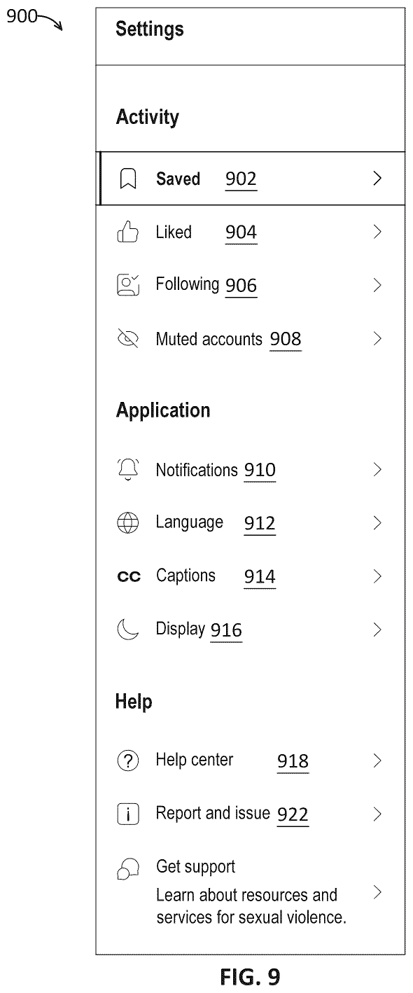

FIG. 9 shows an exemplary settings user interface 900 for the exemplary training system. Via exemplary settings user interface 900, viewers/trainees may view: saved content 902, liked content 904, content creators or content they are following 906, muted accounts 908. There are also application settings such as notifications 910, language options 912, captions 914, and display options 916. Help links are also accessible including a help center 918 which may provide technical support, a link to report an issue 920 including creating a ticket and receiving technical feedback/support, and a link to resources and services for support 922 on a specific topic (such as sexual violence).

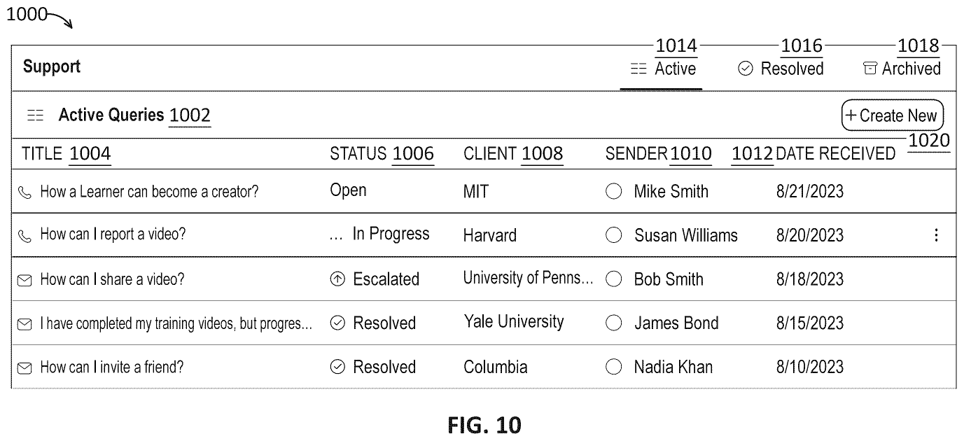

FIG. 10 shows an exemplary support user interface 1000 for the exemplary training system. Viewers/trainees, clients, and other users may access a list of their active queries 1002, with queries filterable by title 1004, status 1006, client 1008, sender 1010, and date received 1012. Queries may also be filtered by active 1014, resolved 1016, and archived 1018 status. Notification settings for email and push notification alerts may be set to notify viewers/trainees or other users when new videos are submitted, when videos are flagged, and a status of video submissions. There is also a clickable button 1020 for creating new queries.

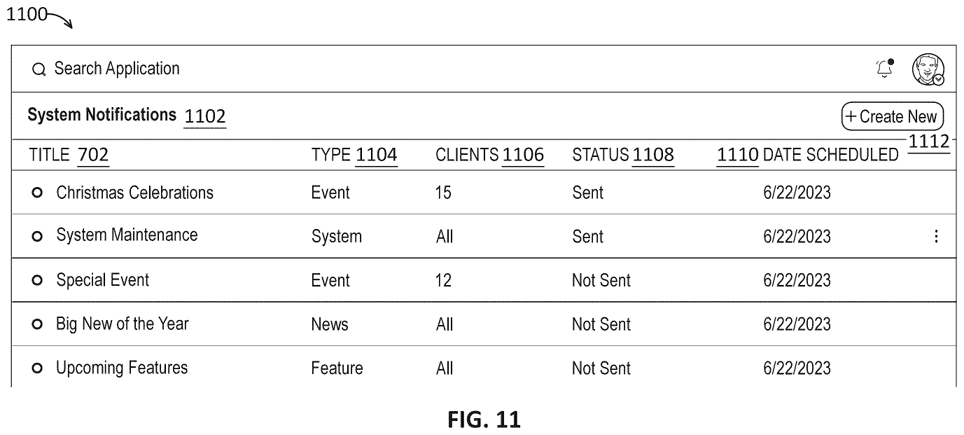

FIG. 11 shows an exemplary system notifications user interface 1100 for the exemplary training system. Viewers/trainees, clients, and other users may view system notifications 1101 including titles 1102, type of notification 1104 such as event notification, system notification, news, and feature notification. Also visible are the number of clients that a notification applies to or is sent to 1106 as well as a notification status 1108, including whether a notification has been sent or not sent, and a date scheduled 1110 for a particular notification. There is also a clickable button 1112 to create and schedule new notifications.

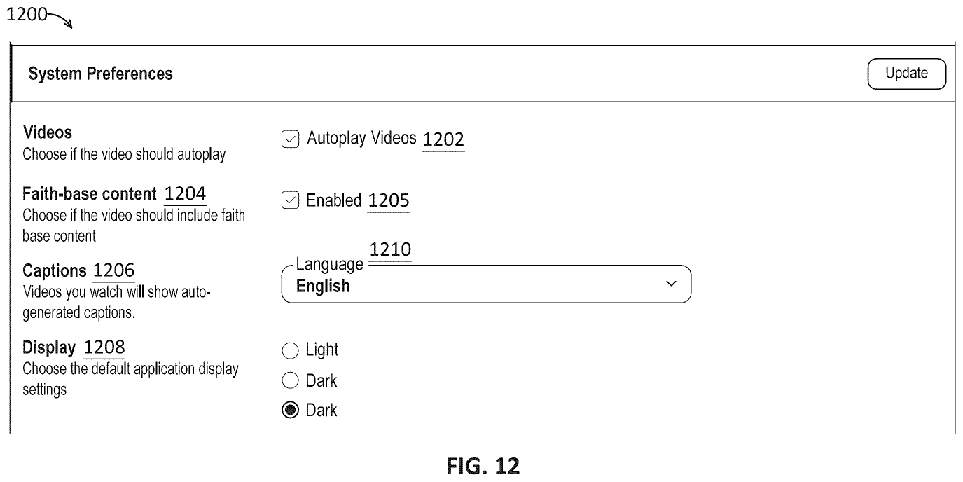

FIG. 12 shows an exemplary system preferences user interface 1200 for the exemplary training system. Viewers/trainees and other parties may select or deselect options to autoplay videos 1202, to enable 1205 or disable videos having faith-based content 1204, to auto-generate captions 1206 for videos, and to modify display settings 1208, such as the options of playing videos in a light mode, dark mode, or system mode. Settings may also include the option to view user interfaces and content in various languages 1210.

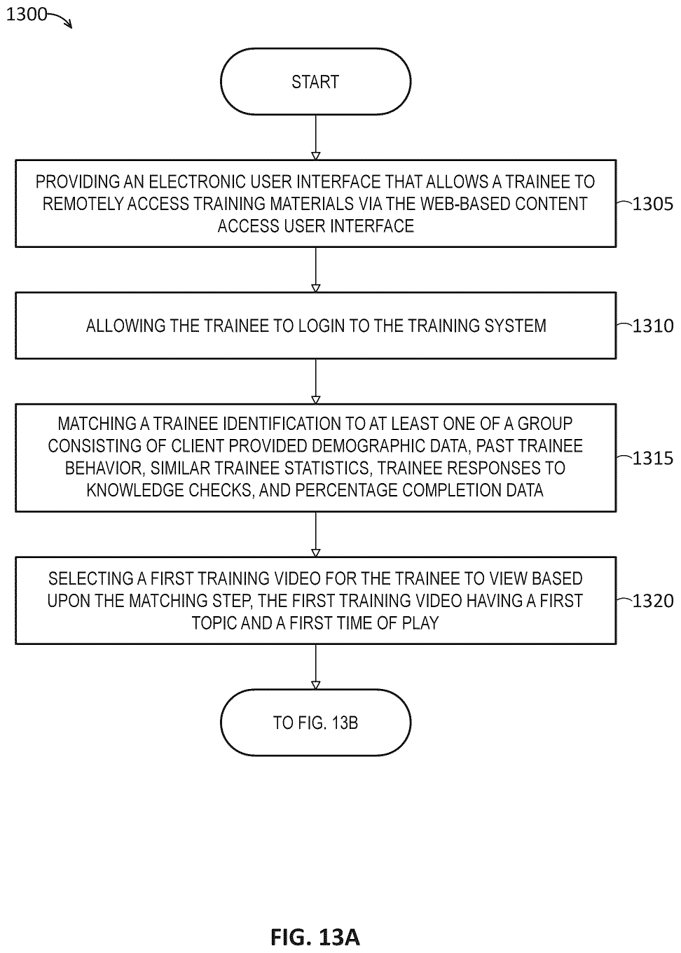

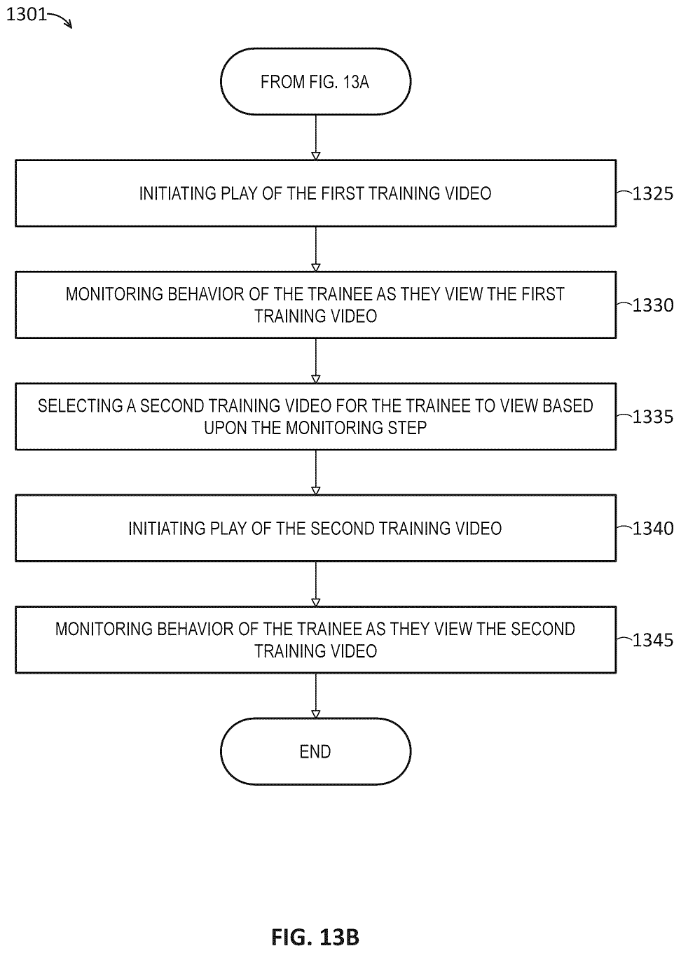

FIGS. 13A-13B is a flow chart illustrating a method 1300-1301 performed in an exemplary training system comprising a web-based content access user interface.

Method 1300-1301 begins at block 1305 with providing an electronic user interface that allows a viewer/trainee to remotely access training materials via the web-based content access user interface.

Method 1300-1301 continues at block 1310 with allowing the viewer/trainee to login to the training system.

Method 1300-1301 continues at block 1315 with matching a trainee identification to at least one of a group consisting of client provided demographic data, past trainee behavior, similar trainee statistics, trainee responses to knowledge checks, and percentage completion data.

Next, method 1300-1301 continues at block 1320 with selecting a first training video for the viewer/trainee to view based upon the matching step, the first training video having a first topic and a first time of play.

Method 1300-1301 continues at block 1325 of FIG. 13B with initiating play of the first training video.

Method 1300-1301 continues at block 1330 with monitoring behavior of the viewer/trainee as they view the first training video.

At block 1335, method 1300-1301 continues with selecting a second training video for the viewer/trainee to view based upon the monitoring step.

Method 1300-1301 continues at block 1340 with initiating play of the second training video.

Method 1300-1301 concludes at block 1345 with monitoring behavior of the viewer/trainee as they view the second training video.

According to certain examples of method 1300-1301, the first monitoring behavior step includes at least one step selected from a group consisting of monitoring whether the viewer/trainee views the first training video in its entirety, rewatches the first training video, partially watches the first training video, responds positively or negatively to the first training video, saves the first training video, and indicates whether they do not want to view the first training video or videos like the first training video (for example, via a “show me less” icon or feature).

According to certain examples of method 1300-1301, the step of monitoring whether the viewer/trainee indicates they do not want to view the first training video includes monitoring whether the viewer/trainee swipes away or clicks away from the first training video.

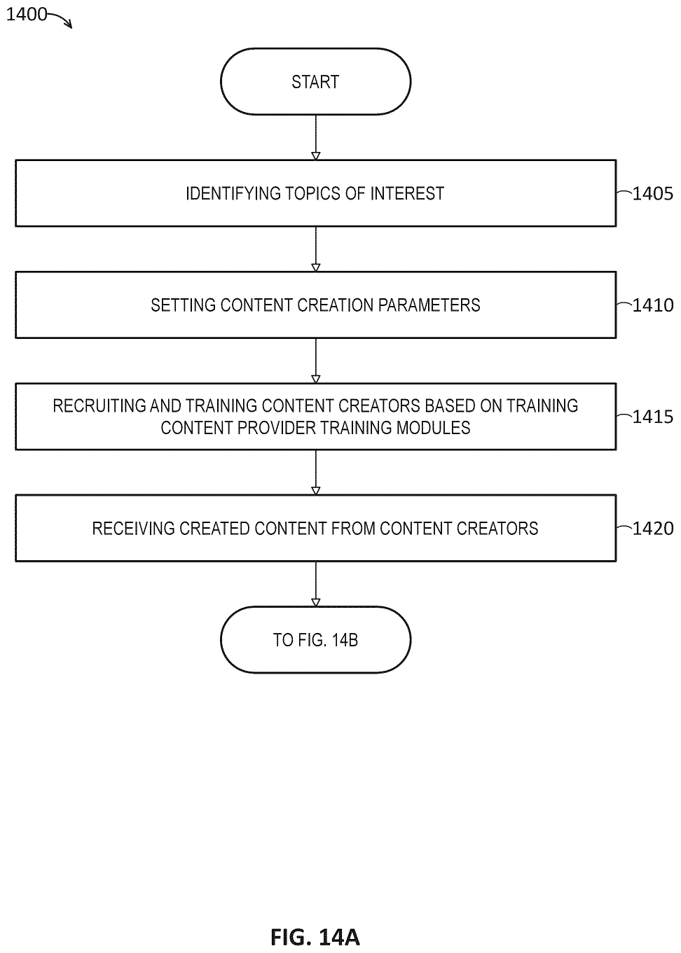

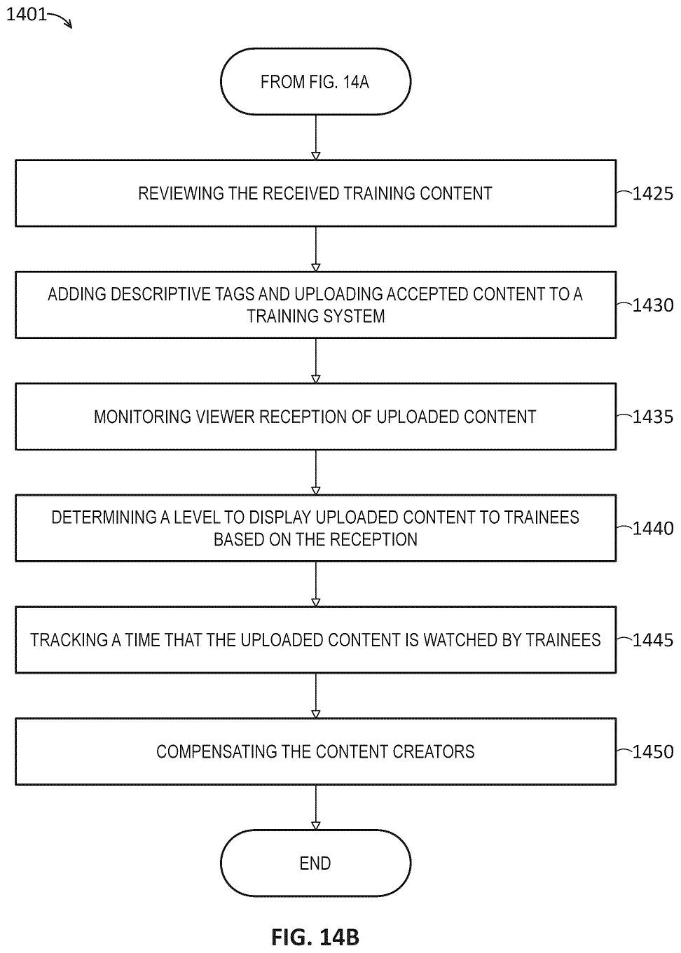

FIGS. 14A-14B is a flow chart illustrating an exemplary method 1400-1401 of creating training content by a training content provider.

The exemplary training system thus may offer a distributed and decentralized content creation model that is subject to approval and moderation by the training system. This may allow for production of engaging content that may be constantly refreshed and improved, with content creators compensated based on the viewer/trainee-driven popularity of their content among viewers/trainees and amount of minutes that their content is watched by viewers/trainees. Such a compensation model may incentivize peer creators to develop content that is accurate and engaging. Providing relevant and engaging training content to viewers/trainees may be designed to build trust and safety within the training and between the viewer/trainee and their institution such as a college or university. In certain examples, viewers/trainees may also be able to choose content most relevant to them and to disregard content and trainings on information they are already familiar with. In such or other examples, the training content provider may purchase, license, or acquire intellectual property rights to content created by the content creators.

Method 1400-1401 begins with identifying topics of interest at block 1405 of FIG. 14A.

Next, at block 1410, content creation parameters are set.

At block 1415, content creators are recruited and trained based on training modules from the training content provider.

At block 1420, content from content creators is received.

Method 1400-1401 continues at block 1425 of FIG. 14B with reviewing the received training content.

At block 1430, descriptive tags are added to accepted content and the accepted content is uploading to a training system.

At block 1435, viewer reception of the uploaded content is monitored.

At block 1440, a level to display uploaded content to viewers/trainees based on the reception is determined.

At block 1445, an amount of time the uploaded content is watched by viewers/trainees is tracked.

Method 1400-1401 ends at block 1450 with compensating the content creators.

According to certain examples of method 1400-1041, topics of interest include public health topics including sexual harassment, sexual health, and alcohol and other drugs.

According to certain examples of method 1400-1401, the training content providers include one or more of trainees, professionals, social media influencers, and general public.

According to certain examples of method 1400-1401, the content provider training modules include one or more of: content creation tips, topic-specific content, and the content creation parameters.

According to certain examples of method 1400-1401, reviewing the received content includes one or more of: accepted content within content creation parameters, revising or moderating the received content, returning the received content to the content creators for resubmission, and rejecting the received content.

According to certain examples of method 1400-1401, determining a level to display uploaded content to viewers is based on one or more of: a user profile of the viewer/trainee, and survey data from viewers.

According to certain examples of method 1400-1401, determining a level to display uploaded content to viewers includes: increasing a frequency and number of viewers/trainees that popular content is displayed to, and reducing a frequency that unpopular content is shown to viewers.

According to certain examples of method 1400-1401, the content creators are compensated based on a threshold time tracked for views of their corresponding uploaded accepted content by viewers/trainees.

According to certain examples of method 1400-1401, the created content from content creators is produced via an application provided by the training content provider, further wherein the application includes an embedded teleprompter feature to display modifiable text and other data while content creators record the created content, wherein the embedded teleprompter feature is configured to maintain eye contact between the content creator and a recording camera recording the created content.

According to certain examples of method 1400-1401, the modifiable text and other data is configured to allow the content creators to adjust one or more of a color, size, display speed, and play/pause status of the text and other data in real-time.

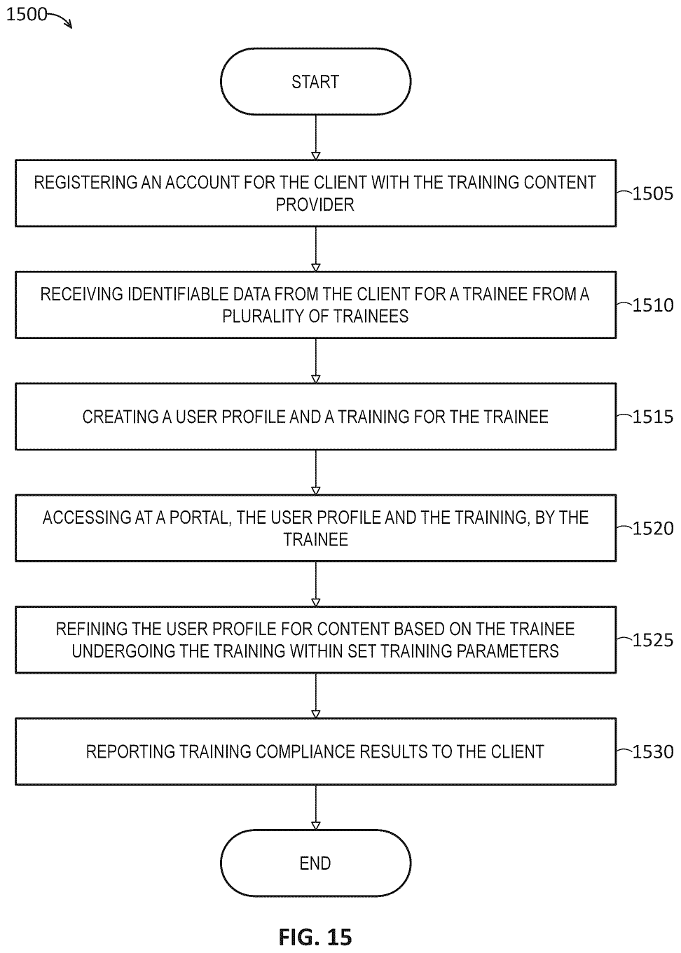

FIG. 15 is a flow chart illustrating an exemplary method 1500 of engagement between a client and a training content provider.

In certain examples, the client may subscribe to access the training system or pay a flat fee per training or course.

Training content may be continually assessed and refined by surveys such as climate survey data to assess the effectiveness of specific content for specific goals such as a decrease in the number of sexual violence incidents on a client's university campus.

At block 1505, an account for the client is registered with the training content provider. In certain examples, the client may subscribe to access the training system or pay a flat fee per training or course.

At block 1510, identifiable data is received from the client for a viewer/trainee from a plurality of viewers/trainees.

At block 1515, a user profile and training is created for the viewer/trainee.

At block 1520, the user profile and the training is accessed by the viewer/trainee at a portal.

At block 1525, the user profile is refined for content based on the trainee undergoing the training within set training parameters.

At block 1530, method 1500 concludes with reporting training compliance results to the client.

According to certain examples of method 1500, the client's account is maintained, upgraded, or downgrade based on the training compliance results.

According to certain examples of method 1500, one or more of the training, set training parameters, and client account parameters are modified based on the training compliance results.

According to certain examples of method 1500, the set parameters include one or more of: time and topical requirements set between the training content provider and the client, laws and regulations, and training content provider best practices.

According to certain examples of method 1500, the portal is accessed via a single sign on (SSO) for the client.

According to certain examples of method 1500, the training content provider hosts one or more of the client account and portal.

According to certain examples of method 1500, reporting training compliance results to the client includes analyzing the results compared to one or more of: surveys, federal or state laws, statistics, conduct records, and tracker data.

The exemplary training system thus may offer a distributed and decentralized content creation model that is subject to approval and moderation by the exemplary training system. This allows production of engaging content that may be constantly refreshed and improved, with content creators compensated based on the viewer/trainee-driven popularity of content among viewers/trainees and amount of minutes that their content is watched by viewers/trainees. Such a compensation model may incentivize peer creators to develop content that is accurate and engaging. Providing relevant and engaging training content to viewers/trainees may be designed to build trust and safety within the training and between the viewer/trainee and their institution such as a college or university. In certain examples, viewers/trainees may also be able to choose content most relevant to them and to disregard content and trainings on information they are already familiar with. In certain examples, the training content provider may purchase, license, or acquire intellectual property rights to content created by the content creators.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts (provided such concepts are not mutually inconsistent) are contemplated as being part of the inventive subject matter disclosed herein and may be used to achieve the benefits described herein.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled”to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that is “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A training system, including a web-based content access user interface, comprising a processor and a non-transitory computer-readable medium including computer executable instructions for configuring the processor to carry out a method including:
providing an electronic user interface that allows a trainee to remotely access training materials via the web-based content access user interface;
allowing the trainee to login to the training system;
matching a trainee identification to at least one of a group consisting of client provided demographic data, past trainee behavior, similar trainee statistics, trainee responses to knowledge checks, and percentage completion data;
selecting a first training video for the trainee to view based upon the matching step, the first training video having a first topic and a first time of play;
initiating play of the first training video;
monitoring behavior of the trainee as they view the first training video;
selecting a second training video for the trainee to view based upon the monitoring step;
initiating play of the second training video; and
monitoring behavior of the trainee as they view the second training video; wherein one or more of the first and second videos are configured to engage the trainee with trainee-determined relevant content based on the monitored behavior of the trainee, wherein at least one of the videos selected by the system for the trainee to view are tailored to the trainee based on the monitored behavior; wherein the monitored behavior includes social media related behaviors including swiping, and a duration of the at least one of the videos watched by the trainee.

2. The training system of claim 1, wherein the first monitoring behavior step comprises at least one step selected from a group consisting of monitoring whether the trainee views the first training video in its entirety, rewatches the first training video, partially watches the first training video, responds positively or negatively to the first training video, saves the first training video, and indicates whether they do not want to view the first training video.

3. The training system of claim 2, wherein the step of monitoring whether the trainee indicates they do not want to view the first training video comprises monitoring whether the trainee swipes away or clicks away from the first training video.

4. The training system of claim 1, further comprising refining an algorithm used to match the trainee identification to training materials, the refining of the algorithm including at least one step selected from a group consisting of monitoring additional trainee behavior, comparing statistics from similar trainees or similar identities, analyzing a percentage of completion of training materials by time or topics, computing a number of seconds of videos watched, and analyzing a long term effectiveness of particular training materials.

5. The training system of claim 4, wherein the refining of the algorithm used to match the trainee identification to training materials includes an artificial intelligence method comprising:
gathering trainee use data from multiple trainees;
cleansing and transforming the use data;
storing the use data for analysis;
inputting the stored use data into a modeling and training process to arrive at a preliminary training material content recommendation for the trainee;
testing the preliminary recommendation to arrive at a final vetted recommendation; and
providing the final recommendation to the trainee.

6. The training system of claim 1, wherein the first training video and the second training video are created by one or more of: peers of the trainee and non-peer experts, wherein one or more of the peers and non-peer experts expand a content library of the training system based on trainee-determined popularity of the first training video and the second training video.

7. The training system of claim 6, wherein the first training video and the second training video are curated by operators of the training system before they can be viewed by the trainee.

8. The training system of claim 7, wherein one or more of the peers of the trainee and the non-peer experts are compensated by the operators of the training system for creating the first training video and the second training video based on trainee-determined popularity of the first training video and the second training video.

9. The training system of claim 1, wherein the web-based content access user interface comprises a client application.

10. The training system of claim 9, wherein the client application is configured to run on a smart phone.

11. The training system of claim 1, wherein the web-based content access user interface comprises a client web browser accessing a website of an operator of the training system.

12. The training system of claim 1, wherein the training materials comprise training content on one or more of: sexual harassment, misconduct, public health, and legal compliance.

13. The training system of claim 12, wherein the training system is further configured to track trainee compliance and provide certification.

14. The training system of claim 12, wherein the training materials comprise student-facing or employee-facing training around sexual and interpersonal violence and harassment under the Clery Act of 1990, Title IX of the Education Amendments of 1972, and other relevant federal and state laws.

15. A method, performed in a training system comprising a web-based content access user interface, the method including:
providing an electronic user interface that allows a trainee to remotely access training materials via the web-based content access user interface;
allowing the trainee to login to the training system;
matching a trainee identification to at least one of a group consisting of client provided demographic data, past trainee behavior, similar trainee statistics, trainee responses to knowledge checks, and percentage completion data;
selecting a first training video for the trainee to view based upon the matching step, the first training video having a first topic and a first time of play;
initiating play of the first training video;
monitoring behavior of the trainee as they view the first training video;
selecting a second training video for the trainee to view based upon the monitoring step;
initiating play of the second training video; and
monitoring behavior of the trainee as they view the second training video;
wherein one or more of the first and second videos are configured to engage the trainee with trainee-determined relevant content based on the monitored behavior of the trainee, wherein at least one of the videos selected by the system for the trainee to view are tailored to the trainee based on the monitored behavior; wherein the monitored behavior includes social media related behaviors including swiping, and a duration of the at least one of the videos watched by the trainee.

16. The method of claim 15, wherein the first monitoring behavior step comprises at least one step selected from a group consisting of monitoring whether the trainee views the first training video in its entirety, rewatches the first training video, partially watches the first training video, responds positively or negatively to the first training video, saves the first training video, and indicates whether they do not want to view the first training video.

17. The method of claim 16, wherein the step of monitoring whether the trainee indicates they do not want to view the first training video comprises monitoring whether the trainee swipes away or clicks away from the first training video.

18. A non-transitory computer-readable medium including computer executable instructions for carrying out a method, performed in a training system comprising a web-based content access user interface, the method including:
providing an electronic user interface that allows a trainee to remotely access training materials via the web-based content access user interface;
allowing the trainee to login to the training system;
matching a trainee identification to at least one of a group consisting of client provided demographic data, past trainee behavior, similar trainee statistics, trainee responses to knowledge checks, and percentage completion data;
selecting a first training video for the trainee to view based upon the matching step, the first training video having a first topic and a first time of play;
initiating play of the first training video;
monitoring behavior of the trainee as they view the first training video;
selecting a second training video for the trainee to view based upon the monitoring step;
initiating play of the second training video; and
monitoring behavior of the trainee as they view the second training video;
wherein one or more of the first and second videos are configured to engage the trainee with trainee-determined relevant content based on the monitored behavior of the trainee, wherein at least one of the videos selected by the system for the trainee to view are tailored to the trainee based on the monitored behavior; wherein the monitored behavior includes social media related behaviors including swiping, and a duration of the at least one of the videos watched by the trainee.

19. The non-transitory computer-readable medium of claim 18, wherein the first monitoring behavior step comprises at least one step selected from a group consisting of monitoring whether the trainee views the first training video in its entirety, rewatches the first training video, partially watches the first training video, responds positively or negatively to the first training video, saves the first training video, and indicates whether they do not want to view the first training video.

20. The non-transitory computer-readable medium of claim 19, wherein the step of monitoring whether the trainee indicates they do not want to view the first training video comprises monitoring whether the trainee swipes away or clicks away from the first training video.

21-37. (canceled)

38. The training system of claim 1, wherein the training materials and training videos are presented to the trainee on behalf of a client institution including government, academia, and corporate institutions; wherein engaging the trainee with the training videos is configured to develop trust and safety between between one or more of: the trainee and the client institution, and the trainee and the training materials; wherein the trainee is a member of the client institution.
